(19) United States
(12) Patent Application Publication
(10) Pub. No.: US 2026/0105341 A1
(43) Pub. Date: Apr. 16, 2026

(54) QUANTUM COMPUTING ARRANGEMENT AND QUANTUM COMPUTER

(71) Applicant: eleQtron GmbH, Siegen (DE)

(72) Inventors: Michael Johanning, Siegen (DE); Sebastian Bock, Berlin (DE); Pedram Yaghoubi, Siegen (DE); Patrick Huber, Herdorf (DE); Patrick Barthel, Burbach (DE); Christof Wunderlich, Siegen (DE); Theeraphot Sriarunothai, Siegen (DE)

(21) Appl. No.: 19/114,573

(22) PCT Filed: Sep. 26, 2023
(86) PCT No.: PCT/EP2023/076532

§ 371 Date: Mar. 24, 2025

(30) Foreign Application Priority Data
Sep. 26, 2022 (DE) 102022124653.1

(51) Int. Cl. G06N 10/40; H01F 1/057

(52) U.S. Cl. CPC G06N 10/40; H01F 1/057

(57) ABSTRACT

In an embodiment a quantum computing arrangement includes a permanent magnet arrangement and a space within the permanent magnet arrangement configured for at least two trapped quantum particles arranged along a first axis, wherein the permanent magnet arrangement includes a plurality of segments, wherein each segment has a magnetisation direction, wherein the magnetisation directions of at least four segments are different to one another thereby establishing a magnetic field with magnitudes being different from one another for different positions on the first axis, and wherein a change of the magnitudes is at least 0.5 T/m.

### CROSS-REFERENCE TO RELATED APPLICATIONS

This patent application is a national phase filing under section 371 of PCT/EP2023/076532, filed Sep. 26, 2023, which claims the priority of German patent application no. 102022124653.1, filed Sep. 26, 2022, each of which is incorporated herein by reference in its entirety.

### TECHNICAL FIELD

The present disclosure relates to a quantum computing arrangement and a quantum computer.

### BACKGROUND

For many quantum computing processes using quantum computing arrangements, the arrangements can be configured to trap trapped quantum particles. The trapped quantum particles have to be controlled and manipulated in order to perform calculations. For charged trapped quantum particles, an interaction as e.g. Coulomb repulsion creates a coupling of neighbouring trapped quantum particles and enables entanglement. Thus, in order to perform quantum computing processes using the trapped quantum particles, the trapped quantum particles have to be controllable and addressable individually from one another.

An individual addressing of a plurality of trapped quantum particles, e.g. a quantum bit register, is desirable with negligible crosstalk. However, a crosstalk between neighbouring trapped quantum particles is typically a difficult source of error to control in a quantum computer processes and can prevent a meaningful application of quantum error correction protocols and thus a scalability.

### SUMMARY

Embodiment provide a quantum computing arrangement having an improved controllability. Further embodiments provide a quantum computer comprising such a quantum computing arrangement.

According to at least one embodiment, the quantum computing arrangement comprises a permanent magnet arrangement. The permanent magnet arrangement has, for example, a first axis. The permanent magnet arrangement has a main extension plane, wherein the first axis extends along the main extension plane.

The first axis is a virtual axis. The first axis is, for example, an axisymmetric axis within the main extension plane. This is to say that the first axis splits the permanent magnet arrangement in cross sectional view along the main extension plane in two halves and a shape of the two halves is essentially identical. “Essentially identical” means exemplarily that due to manufacturing tolerances of the permanent magnet arrangement, the halves, e.g. an area of the cross sections of the halves, can differ at most by 5% or at most by 1% to one another.

According to at least one embodiment, the quantum computing arrangement comprises a space within the permanent magnet arrangement for at least two trapped quantum particles, wherein the at least two trapped quantum particles are arranged along a first axis. Exemplarily, the space has a main extension direction extending along the first axis.

For example, the permanent magnet arrangement surrounds the space. The space is defined as an area or volume, being surrounded by the permanent magnet arrangement, where the quantum particles are trapped during operation of the quantum computing arrangement. Exemplarily, the trapped quantum particles are arranged linearly next to one another along the first axis during operation of the quantum computing arrangement. In particular, during operation of the quantum computing arrangement more than two, e.g. at least 8, at least 20 or at least 100 and/or at most 1000, trapped quantum particles are arranged along the first axis.

The trapped quantum particles are represented, for example, by energy levels in atoms or molecules, by spins of electrons and/or nuclei, charges, fluxes or phases in superconductors or topological quantum numbers of anyons in a topological protected system.

For example, the space is located within a vacuum environment and/or a cryogenic environment.

Exemplarily, each trapped quantum particle is trapped by a predetermined trap potential. The trap potential can be static or dynamic. For trapped quantum particles represented by energy levels in atoms or molecules, ions are trapped by electromagnetic fields. Exemplarily, ions are trapped by dynamic electric fields, particularly radio frequency fields. For trapped quantum particles being represented by the spins of electrons, electrons are trapped in a potential well within a semiconductor system. For example, the trapped quantum particles are charged trapped quantum particles.

According to at least one embodiment of the quantum computing arrangement, the permanent magnet arrangement comprises a plurality of segments, namely at least four segments. E.g. the permanent magnet arrangement comprises at least four segments, in particular at least 8 segments, at least 16 or at least 32 segments. Each segment comprises a permanent magnetic material. In particular, each of the segments comprises the same permanent magnetic material. Exemplarily, the permanent magnetic material comprises a ferromagnetic material.

Each segment is formed, for example, in one piece. Alternatively, each segment is formed from at least two sub-segments, wherein the at least two sub-segments have the same material and/or magnetisation properties.

The first axis extends in a preferred embodiment linearly from one of the segments to another of the segments being located directly opposite to said one of the segments with respect to a centre of the permanent magnet arrangement.

Exemplarily, the permanent magnet arrangement is a Halbach arrangement.

According to at least one embodiment of the quantum computing arrangement, each segment has a magnetisation direction. A magnetisation of each segment is defined by a vector field being representative of dipole moments of the respective permanent magnetic material. This is to say that the respective permanent magnetic material exhibits dipole moments. The vector field, in particular the dipole moments of the permanent magnetic material, define the respective magnetisation direction. The dipole moments largely point in the magnetisation direction.

Each magnetisation direction is defined with respect to the first axis. This is to say that each magnetisation direction enclose an angle with the first axis.

According to at least one embodiment of the quantum computing arrangement, the magnetisation directions of the at least four segments are different to one another, thereby establishing a magnetic field with magnitudes being different from one another for different positions on the first axis. Exemplarily, the magnitude of the magnetic field is changing along the first axis for different positions on the first axis. The magnitude is, for example, symmetrical with respect to the centre of the permanent magnet arrangement along the first axis. This is to say that there are two points with identical magnitude on the first axis, for example.

For example, all magnetisation directions of the segments are different to one another. This is to say that that each magnetisation direction has a different angle with respect to the first axis. In other words, all angles that are enclosed by the magnetisation directions and the first axis are different form one another.

An arrangement of the segments as well as the respective magnetisation direction of each segment is predetermined in such a way that a magnetic multipole field is generated. In particular, a magnetic quadrupole field is generated, wherein in the centre of the permanent magnet arrangement the magnitude of the magnetic field is vanishing, e.g. being approximately 0 T. Due to the magnetic multipole field, particularly the quadrupole field, the permanent magnet arrangement has a magnitude of the magnetic field along the first axis dependent on the arrangement of the segments and the respective magnetic directions.

For such a permanent magnet arrangement, the magnitude of the magnetic field is changing continuously along the first axis, i.e. for different positions on the first axis. Thus, the magnitudes of the magnetic field for different positions on the first axis is characteristic for a magnetic field gradient along the first axis.

The magnetic field is represented by a magnetic flux density. Further, an absolute value of the magnetic flux density corresponds to the magnitude of the magnetic field for a predetermined position on the first axis.

Vectors being components of the magnetic field can point in any direction with respect to the first axis. This is to say that at least some of the vectors of the magnetic field for different positions on the first axis can have different angles with respect to the first axis. For example, at least some of the vectors of the magnetic field point in radial direction of the first axis or in axial direction of the first axis.

For example, at least some of the vectors of the magnetic field point in the same radial direction and/or in the same axial direction of the first axis for different positions on the first axis. Alternatively or additionally, at least some of the vectors of the magnetic field are rotated in radial direction of the first axis with respect to one another.

A distribution of the magnitude of the magnetic field is symmetrically with respect to the centre of the permanent magnet arrangement along the first axis. Exemplarily, the first axis is split into two halves by the centre of the permanent magnet arrangement. This is to say that for every point on the first axis in one half there is a further point on the first axis in the other half with the same magnitude of the magnetic field. The magnitude of the magnetic field has a negative slope for the one half and a positive slope for the other half. The magnetic field gradient grows along the first axis, with respect to the magnitude of the magnetic field along the first axis starting from the centre, for example, approximately linearly. This is to say that the magnetic field gradient is approximately constant along the first axis starting from the centre.

If there are m segments, wherein m is an even natural number of at least 4, the magnetisation directions of the two directly neighbouring segments are rotated by 360°·3/m with respect to one another.

Particularly, the magnitudes of the magnetic field in the centre region being established by the permanent magnet arrangement change by at least 0.5 T/m or and at most 500 T/m. In particular, the magnitudes of the magnetic field in the centre region change by at least 50 T/m and at most 250 T/m, exemplarily 150 T/m.

It is an idea, inter alia, to use the permanent magnet arrangement in combination with the space, where the trapped quantum particles are located during operation of the quantum computing arrangement. The different magnitudes of the magnetic field, i.e. the magnetic field gradient of the permanent magnet arrangement, makes equilibrium positions of the trapped quantum particles state dependent. Furthermore a resonance frequency is unique for each trapped quantum particle due to the magnetic field gradient.

This is to say that due to the different magnitudes of the magnetic field, i.e. the magnetic field gradient of the permanent magnet arrangement, the trapped quantum particles can be addressed individually in frequency space such that an improved multi-quantum bit gate can be advantageously implemented and a coupling of neighbouring trapped quantum particles can be controlled. Furthermore, by adjusting the coupling, highly entangled cluster states can be generated advantageously used for quantum computation.

For example, each trapped quantum particle is represented by a two-level quantum system. If no magnetic field is applied to a two-level quantum system, the two-level quantum system comprises a first level and a second level, wherein both levels correspond to a respective eigenstate of the respective trapped quantum particle. For example, the first level represents a ground state of the respective trapped quantum particle and the second level represents an excited state of the respective trapped quantum particle.

Exemplarily, if the magnetic field is applied to the two-level quantum system, a degeneracy of the second level is lifted such that at least two, in particular at least three, sub-levels are generated. This results in two, in particular three, possible transitions from each of the two, in particular three, sub-levels to the first level.

If the trapped quantum particles are represented by n-level quantum systems, wherein n is a natural number equal or bigger than two, each n-level quantum system comprise n levels. For example, at least some of the n-levels correspond to a sub-level, when the magnetic field is applied. In such an n-level quantum system, a plurality of transitions are achievable.

Furthermore, a strength of a splitting of the levels, as well as a splitting of the sub-levels, is dependent on the applied magnetic field. For the trapped quantum particles the magnitudes of the magnetic field are different for different positions and thus, the splitting is also different for these trapped quantum particles. Therefore, also a frequency difference of a specific transition between neighbouring trapped quantum particles is achieved. Due to the frequency differences also different resonance frequencies for the neighbouring trapped quantum particles are resulting.

A total energy of each of the trapped quantum particles is predetermined by the trap potential and an energy being characteristic for the respective transition.

If the trap potential, for example, a harmonic trap potential, is superimposed with the levels and sub-levels of the respective trapped quantum particle, equilibrium positions are dependent on the state of the respective trapped quantum particle. If a trapped quantum particle being in the ground state is excited to one of the excited states, e.g. according to one of the possible transitions, an equilibrium position of the trapped quantum particle changes. Due to the change of the equilibrium position, an effective spin-spin coupling of the trapped quantum particle with neighbouring trapped quantum particles is achieved via a Coulomb interaction. Thus, the equilibrium positions are dependent on a state of each of the trapped quantum particles as well as on the magnitudes of the magnetic field, i.e. the magnetic field gradient.

This is to say that the coupling of the at least two trapped quantum particles is dependent on the magnitudes of the magnetic field, i.e. the magnetic field gradient. Since the coupling is proportional to a square of the magnetic field gradient, the magnetic field gradient has to be large enough to create sufficient coupling for fast computation, which can be realized with the permanent magnet arrangement described herein. This is to say that the magnetic field gradient has to be large enough to create a coupling being large compared to the decoherence rate. Such a comparatively large gradient improves an addressing as well as provides a lower crosstalk and a stronger coupling of the trapped quantum particles. Therefore, faster quantum operations are achievable and less error correction operations are required.

Advantageously, with the permanent magnet arrangement of the quantum computing arrangement described herein, the magnetic gradient is particularly high, while having a limited available solid angle and distance with respect to the space of the trapped quantum particles. Thus, such a quantum computing arrangement can be implemented in a variety of systems.

In sum, the permanent magnet arrangement is used for obtaining large magnetic field gradients experienced by charged trapped quantum particles to create largely different magnetic fields seen by individual trapped quantum particles. In a quantum information environment this allows for advanced addressing in frequency space and thus individual single qubit rotations with low cross-talk, and to introduce a coupling between charged trapped quantum particles to allow for interactions, thus enabling multi-qubit gates. This can also be used in connection with radio frequency, RF, fields for qubit control, for which addressing by focusing radiation is not an option due to the long wavelength, but RF fields might offer advantages in terms of miniaturization, integration. For this purpose large or steep magnetic field gradients are desirable, allowing for better addressing and faster quantum gates with higher fidelity, and the permanent magnet arrangement, which is in particular a Halbach arrangement, allows for large magnetic field gradients even when the distance between the segments of the permanent magnet arrangement and quantum particles is limited by technical constraints.

According to at least one embodiment of the quantum computing arrangement, the segments surround the space in the form of a ring or the segments surround the space in the form of a contour of a polygon.

The ring or the contour of the polygon are of virtual nature. Exemplarily, in cross sectional view along the main extension plane, each segment is arranged on a point, wherein the points are located on the ring or the contour of the polygon. The points are spaced apart from one another, such that also the sections do not overlap with one another in the main extension plane. For example, each point is representative for a centre of a respective segment.

In case of the segments being arranged on the ring, a shape of the ring is a circle or an ellipse. In case of the segments being arranged on the contour of the polygon, a shape of the contour of the polygon can be a quadrangle, a rectangle, a hexagon or an octagon.

For example, directly neighbouring segments being arranged on the ring or the contour of the polygon, are in direct and immediate contact to one another and/or have a distance to one another of at most 50 mm, in particular of at most 1 mm. Due to such a comparatively small distance, the magnetic field resembles advantageously a smooth quadrupole field and thus, also the magnetic field gradient along the first axis, is particular linear.

According to at least one embodiment of the quantum computing arrangement, the space is located at a centre region of the ring or the contour of the polygon. The centre region is enclosed by the ring or the contour of the polygon and arranged at the centre of the permanent magnet arrangement.

Exemplarily, the magnetic field gradient along the first axis, is approximately linear along the first axis within the centre region. Deviations of at most 5% from the linearity can be present due to production tolerances of the segments, exemplarily, within the centre region.

According to at least one embodiment of the quantum computing arrangement, distances between directly neighbouring segments are equal to one another. Exemplarily, the segments arranged on the ring or the contour of the polygon are arranged equidistantly to one another. Deviations from at most 5% from an average distance can be present due to production tolerances.

According to at least one embodiment of the quantum computing arrangement, a cross section of at least some of the segments has the shape of a quadrangle. Segments having the quadrangle shape in the cross section along the main extension plane are particularly easy to produce and thus particularly cost saving.

According to at least one embodiment of the quantum computing arrangement, a cross section of at least some of the segments has the shape of a trapezoid. The trapezoid has four opposing edges.

Exemplarily, all edges are formed straight. Advantageously, edges of directly neighbouring segments can be arranged advantageously close to one another. This is to say that edges of directly neighbouring segments facing one another can be advantageously in direct contact to one another or at least be comparatively close together over the entire length of these edges.

Furthermore, in order to generate the magnetic field gradient being particularly high, the permanent magnet arrangement has to be as close as possible to the space. Advantageously, having the trapezoidal segments, the edges facing the space of each segment can be comparatively close to the space compared to the quadrangle segments over the entire length of these edges.

Alternatively, two opposing edges facing the space are formed curved. In particular, a normal bundle of the two opposing edges points away from space. Advantageously, distances of edges of the segments facing the space to the space are approximately of the same size, in comparison with the segments having the straight edges. Thus, the magnetic multipole field can be particularly smooth resulting in a particular smooth magnetic field gradient.

According to at least one embodiment of the quantum computing arrangement, all segments have the same shape. For example, each segment is formed of a cuboid, a prism or a truncated pyramid. In particular, all segments have the same dimensions, e.g. width, length and height.

According to at least one embodiment of the quantum computing arrangement, the magnetisation directions of segments being arranged at opposite regions are directed in opposite directions. The segments are arranged with respect to the centre region at opposite regions. The magnetisation directions of segments being arranged at opposite regions are diametrical to one another.

In particular, the first axis is defined with respect to two segments being arranged opposite to one another, wherein the magnetisation directions of the respective two segments are parallel to the first axis.

According to at least one embodiment of the quantum computing arrangement, at least some of the trapped quantum particles of the space form an at least two-level quantum system during operation of the quantum computing arrangement and/or at least some of the trapped quantum particles of the space form a quantum bit, qubit for short, during operation of the quantum computing arrangement.

According to at least one embodiment of the quantum computing arrangement, a frequency difference of a specific transition between the trapped quantum particles is dependent on the magnitude of the magnetic field during operation of the quantum computing arrangement. Since the trapped quantum particles are arranged along the first axis and since the magnetic field has the different magnitudes along the first axis, there is a frequency difference of same transitions between neighbouring trapped quantum particles. This is to say that a resonant frequency with respect to a specific transition of each of the trapped quantum particles is dependent on a position of each of the trapped quantum particles on the first axis.

According to at least one embodiment of the quantum computing arrangement, a distance of directly neighbouring trapped quantum particles is at least 0.1 μm and at most 30 μm. The distance of directly neighbouring trapped quantum particles is, for example, 5 μm. For example, the distances of directly neighbouring trapped quantum particles can vary along the first axis in space and in time.

The plurality of trapped quantum particles can be part of a quantum crystal, in particular a Coulomb crystal. If the trapped quantum particles are trapped ions, the quantum crystal is an ion crystal. Exemplary, the space within the permanent magnet arrangement can be configured to host at least two quantum crystal. The quantum crystal can be spaced apart from one another by at least 5 μm and most 500 μm, in particular by at least 50 μm and most 100 μm.

According to at least one embodiment of the quantum computing arrangement, a frequency difference of a transition, in which the magnetic quantum number changes, between directly neighbouring trapped quantum particles is at least 10 kHz and at most 100 MHz. In particular, the frequency difference of the transition, in which the magnetic quantum number changes, between directly neighbouring trapped quantum particles is at least 1 MHz and/or at most 50 MHz.

If the trapped quantum particles are represented by the two-level quantum systems with three sub-levels, two of the three possible transitions are each a so called ot-transition, wherein a magnetic quantum number of the respective sub-levels to the first level does change. Such a σ±-transition is excited by a left- or right-circularly polarised electromagnetic wave with a polarization perpendicular to the local magnetic field.

The frequency difference of the σ±-transition between directly neighbouring trapped quantum particles is, for example, at least 10 kHz, at least 1 MHz or at least 10 MHz, approximately 40 MHz.

According to at least one embodiment of the quantum computing arrangement, a frequency difference of a transition, in which the magnetic quantum number does not change, between directly neighbouring trapped quantum particles is at least 1 kHz and at most 10 MHz.

If the trapped quantum particles are the two-level quantum systems, one of the three possible transitions is a so called π-transition, wherein a magnetic quantum number of the respective sub-level to the first level does not change. Such a π-transition is excited by a linearly polarised electromagnetic wave with a polarization parallel to the local magnetic field with a polarization parallel to the local magnetic field.

The frequency difference of the π-transition between directly neighbouring trapped quantum particles is, for example, approximately 0.25 MHz.

According to at least one embodiment of the quantum computing arrangement, edges of segments being arranged at opposite regions and facing one another have a minimal distance from one another of at least 0.001 cm and at most 100 cm. In particular, the minimal distance is at least 0.01 cm or at least 1 cm and at most 25 cm or at most 50 cm. In this context, opposite means, for example, opposite with respect to a centre of gravity of the permanent magnet arrangement and/or with respect to the centre of the magnetic field, i.e. a centre of the quadrupole field.

For example, the minimal distance divided by two is defined as an inner radius of the permanent magnet arrangement.

According to at least one embodiment of the quantum computing arrangement, each segment has an extent along the corresponding minimal distance of at least 0.001 cm and at most 100 cm. In particular, the extent is at least 0.01 cm or at least 1 cm and at most 25 cm or at most 50 cm.

For example, the minimal distance divided by two and the extent along the corresponding minimal distance is defined as an outer radius of the permanent magnet arrangement.

According to at least one embodiment of the quantum computing arrangement, a remanence of each of the segments is at least 0.1 T and at most 1.5 T. In particular, the remanence of each of the segments is at least 0.5 T and/or at most 1 T.

With such a remanence as well as with such inner radii and outer radii, it is achievable that the magnitudes of the magnetic field in the centre region change by at least 0.5 T/m and at most 500 T/m.

If the segments are arranged in the form of a ring, the magnetic flux density \vec{B} corresponding to the magnetic field has the form:

$$\vec{B} = 2 {B}_{R} ( \frac{1}{{R}_{i}} - \frac{1}{{R}_{o}} ) ( \begin{matrix}1 & 0 \\ 0 & - 1\end{matrix} ) ( \begin{matrix}x \\ y\end{matrix} ) ,$$

wherein BR is the remanence of the segments, Ri the inner radius, Ro the outer radius and x and y the coordinates within the permanent magnet arrangement.

According to at least one embodiment of the quantum computing arrangement, the permanent magnet arrangement comprises NdFeB. In particular, the permanent magnet arrangement comprises NdFeB N52. Exemplarily, each segment comprises or consists of NdFeB, in particular NdFEB N52.

According to at least one embodiment, the quantum computing arrangement further comprises at least one additional permanent magnet arrangement. In particular, the quantum computing arrangement can comprise several additional permanent magnet arrangements. The additional permanent magnet arrangement can have the same properties as the permanent magnet arrangement described herein above. Further, the additional permanent magnet arrangement can have the same dimensions than the permanent magnet arrangement described herein above. Alternatively, the additional permanent magnet arrangement can have different dimensions than the permanent magnet arrangement described herein above.

According to at least one embodiment of the quantum computing arrangement, the permanent magnet arrangement and the additional permanent magnet arrangement are rotated relative to each other.

For example, the additional permanent magnet arrangement is arranged with respect to the permanent magnet arrangement in a rotated form, in particular an out of plane rotated form, such that an angle is enclosed by the respective main extension planes. This is that the additional main extension plane of the additional permanent magnet arrangement is rotated out of the plane of the main extension plane of the permanent magnet arrangement. Exemplarily, the angle can be between 0° and 180°, in particular 60°, 120° and/or 90°.

For example, the additional permanent magnet arrangement is rotated by 90° with respect to the permanent magnet arrangement, such that the respective main extension planes enclose an angle of 90°. Exemplarily, the first axis and an additional first axis corresponding to the additional permanent magnet arrangement are positioned perpendicular to one another. Thus, the trapped quantum particles can advantageously be arranged in a cross like manner.

According to at least one embodiment of the quantum computing arrangement, the permanent magnet arrangement and the additional permanent magnet arrangement are parallel to each other.

Exemplarily, the first axis and the additional first axis are positioned parallel to one another.

Alternatively, the additional permanent magnet arrangement is arranged with respect to the permanent magnet arrangement in a rotated form, in particular an in plane rotated form. In this case, the main extension plane and the additional main extension plane are parallel to one another. For such an in plane rotation, an angle is enclosed by the respective first axis, i.e. the first axis and the additional first axis. Exemplary, the angle can be between 0° and 90°.

For example, the additional permanent magnet arrangement is rotated in plane by 90° with respect to the permanent magnet arrangement, such that the respective first axis enclose an angle of 90°. In this embodiment, the first axis and the additional first axis are positioned perpendicular to one another.

Such arrangements comprising the permanent magnet arrangement and the additional permanent magnet arrangement exemplarily each forms—in terms of the magnetic field-a three dimensional confined space, e.g. a three dimensional gradient space.

By adding more than one additional permanent magnet arrangement, more than one additional first axis are provided such that also complex arrangements of trapped quantum particles are conceivable.

Additionally, a quantum computer is specified, wherein the quantum computer comprises a quantum computing arrangement as described herein above. This is to say that the features concerning the quantum computer are also applicable for the quantum computing arrangement and vice versa.

The quantum computer is configured to perform quantum computing processes by using the quantum computing arrangement. The trapped quantum particles of the quantum computing arrangement can be controlled and manipulated particularly well with the permanent magnet arrangement described herein above, in order to perform predetermined quantum calculations.

### BRIEF DESCRIPTION OF THE DRAWINGS

In the following, the quantum computing arrangement is explained in more detail with reference to exemplary embodiments and the associated Figures.

FIGS. 1 and 2 each shows a cross sectional view of a quantum computing arrangement according to an exemplary embodiment;

FIGS. 3 and 4 each shows an exemplary diagram of magnitudes of the magnetic field of a permanent magnet arrangement of a quantum computing arrangement according to an exemplary embodiment;

FIG. 5 shows a quantum computer according to an exemplary embodiment; and

FIGS. 6, 7 and 8 each shows a quantum computing arrangement according to an exemplary embodiment.

Elements that are identical, similar or have the same effect are given the same reference signs in the Figures. The Figures and the proportions of the elements shown in the figures are not to be regarded as true to scale. Rather, individual elements may be shown exaggeratedly large for better representability and/or for better comprehensibility.

### DETAILED DESCRIPTION OF ILLUSTRATIVE EMBODIMENTS

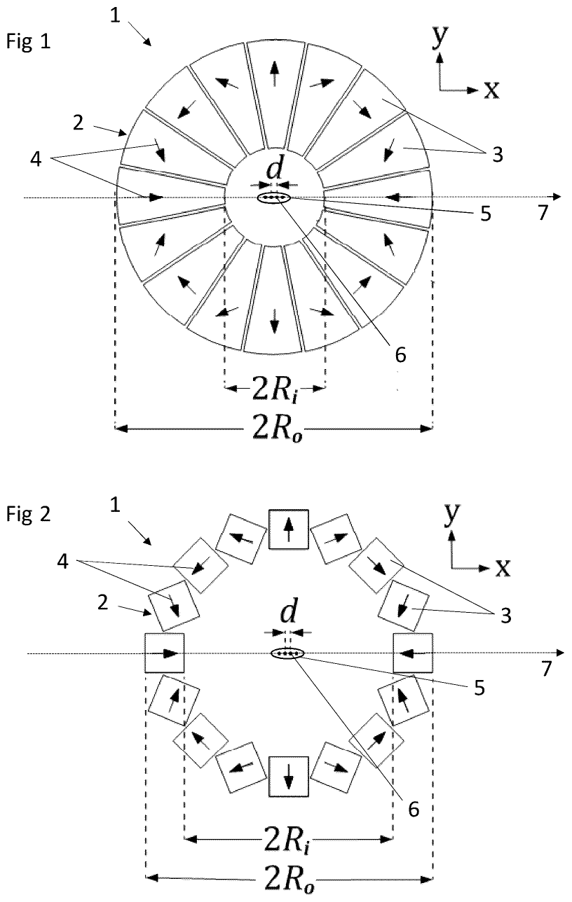

A quantum computing arrangement 1 according to the exemplary embodiment of FIG. 1 comprises a permanent magnet arrangement 2. The permanent magnet arrangement 2 comprises 16 segments 3. The segments 3 surround a space 5 of the quantum computing arrangement, where trapped quantum particles 6 are trapped during operation of the quantum computing arrangement. The segments 3 surround the space 5 in the form of a ring. Each segment 3 is arranged with its centre on a point of the ring.

The permanent magnet arrangement 2 has a main extension plane extending along the x-axis and y-axis shown in FIG. 1. Each segment 3 has cross sectional form of an annulus sector or circular ring sector, wherein all segments 3 share the same common inner ring and same common outer ring. A width of each segment 3 tapers down towards the space 5. That is that opposing edges of each segment 3 facing the space 5 are curved. A normal bundle of the curved edges point away from the space 5. This is to say that a radius of the curved edges are defined with respect to a centre region of the permanent magnet arrangement 2.

The curved edges of segments 3 being arranged at opposite regions with respect to the centre region and facing one another have a minimal distance from one another of approximately 10 cm. The minimal distance divided by two defines an inner radius Ri of the permanent magnet arrangement 2.

Furthermore, each segment 3 has an extent along the corresponding minimal distance being approximately 20 cm. The minimal distance divided by two and the extent along the corresponding minimal distance defines an outer radius Ro of the permanent magnet arrangement 2.

For example, directly neighbouring segments 3 are spaced apart from one another. Edges of directly neighbouring segments 3 facing one another, have a distance to one another of approximately 1 mm.

In this exemplary embodiment, each segment 3 has a line of symmetry that is bisecting opposite edges facing the space 5. The line of symmetry is the same for segments 3 being arranged opposite one another. One of the lines of symmetry represents a first axis 7 of the permanent magnet arrangement 2, wherein the first axis 7 exemplarily extends within the main extension plane.

Furthermore, each segment 3 has a magnetisation direction 4 being depicted as arrows within the segments 3 in FIG. 1. The magnetisation directions 4 of segments 3 being arranged at opposite regions with respect to a centre of the permanent magnet arrangement 2 are directed in opposite directions. The first axis 7 of the permanent magnet arrangement 2 is defined with respect to two segments 3 being arranged opposite to each other, wherein the magnetisation directions 4 of the respective two segments 3 are parallel to the first axis 7.

Each magnetisation direction 4 encloses an angle with the first axis 7. All of these angles are formed differently. For example, the angles of directly neighbouring segments 3 differ by 67.5° from one another.

In the exemplary embodiments of the FIGS. 1 and 2, the first axis 7 points in the direction of the x-axis.

Furthermore, the angle of the segment 3 having a magnetisation direction 4 being parallel to the first axis 7 and pointing in the same direction as the first axis 7 is 0°. The angle of the opposite segment 3 having a magnetisation direction 4 being parallel to the first axis 7 and pointing in the opposite direction as the first axis 7 is 180°.

Going on the ring clockwise from the segment 3 having a magnetisation direction 4 being parallel to the first axis 7 and pointing in the same direction as the first axis 7 back to this segment 3, the magnetisation direction 4 also rotates also clockwise.

With such segments 3, the permanent magnet arrangement 2 is configured to produce a quadrupole field and thus has different magnitudes along the first axis 7, i.e. a magnetic field gradient along the first axis 7. Further, during operation of the quantum computing arrangement 1 the trapped quantum particles 6 are arranged linearly next to one another along the first axis 7.

The magnitudes of the magnetic field, which act on the trapped quantum particles 6, are different for every trapped quantum particle 6 arranged on the first axis 7.

Exemplary, the trapped quantum particle 6 are trapped ions. This is to say each trapped ion has n energy levels, wherein two of the n energy levels form a qubit. In this case each trapped ion is represented by a two-level quantum system comprising a first electronic energy level and a second electronic energy level, wherein both levels correspond to a respective atomic eigenstate of the respective trapped ion.

For trapping ions, an electromagnetic harmonic trap potential is used to confine the to be trapped ions in an axial direction along the first axis. The harmonic trap potential is furthermore superimposed with a magnetic quadrupole potential to confine the to be trapped ions in a radial direction along the first axis. These trapping potentials are superimposed with the electronic energy levels and corresponding electronic energy sub-levels, which emerge due to the different magnitudes of the magnetic field, i.e. the magnetic gradient field. There are transitions between the electronic energy sub-levels each corresponding to an excited state of the trapped ion and the first electronic energy level corresponding to the ground state of the trapped ion. Due to the different magnitudes of the magnetic field, i.e. the magnetic field gradient, there is a frequency difference for specific transitions between neighbouring trapped ions. Thus, each of the trapped ions can be thus excited with a different resonance frequency. Advantageously, each of the trapped ions is distinguishable and thus addressable having such different resonance frequencies.

The total energy of the system is predetermined by the harmonic trap potential and an internal energy. The internal energy is depending on the state of the trapped ion, e.g. being in a ground state or an excited state. If the trapped ion is excited with a specific resonance frequency in one of the excited states, the equilibrium position of the trapped ion changes due to the superposition of the corresponding electronic energy sub-level with the harmonic trap potential. As a consequence, the trapped ion starts to oscillate and thus influences the neighbouring trapped ions via the Coulomb interaction such that an effective spin-spin coupling is obtained.

In particular, a coupling strength between two directly neighbouring trapped ions is dependent on the square of the magnetic field gradient and the square of an axial frequency of the trap potential. Further, a relaxation time, in particular a spin relaxation time T2, is inversely proportional to the decoherence rate. Thus, in order to provide multi-qubit gates, the magnetic field gradient has to be comparatively high to provide a large number of gates within a given time.

For example, the inner radius Ri according to this exemplary embodiment is approximately 5 cm and the outer radius Ro is approximately 25 cm. The remanence B_{R} of each of the segments 3 is, for example, 1 T. Thus, the magnetic field, in particular the corresponding magnetic flux density \vec{B} can be calculated by:

$$\vec{B} = 2 {B}_{R} ( \frac{1}{{R}_{i}} - \frac{1}{{R}_{o}} ) ( \begin{matrix}1 & 0 \\ 0 & - 1\end{matrix} ) ( \begin{matrix}x \\ y\end{matrix} ) .$$

An origin of the coordinates x and y is located at the centre of the permanent magnet arrangement 2.

Furthermore, distances d of directly neighbouring trapped ions approximately 3 μm. Thus, the magnetic flux density \vec{B} can be calculated for each position of the trapped ions. Consequently, also the difference for specific transitions between neighbouring trapped ions can be determined.

The quantum computing arrangement 1 according to the exemplary embodiment of FIG. 2 comprises in contrast to the exemplary embodiment of FIG. 1 a permanent magnet arrangement 2 having segments 3, each having a squared form.

Each segment 3 has cross sectional form of a square. The magnetisation directions 4 with respect to the edges of the squares are the same for each segment 3. Directly neighbouring segments 3 are rotated with respect to one another, such that the magnetisation directions 4 of each segment 3 corresponds to the angles according to FIG. 1.

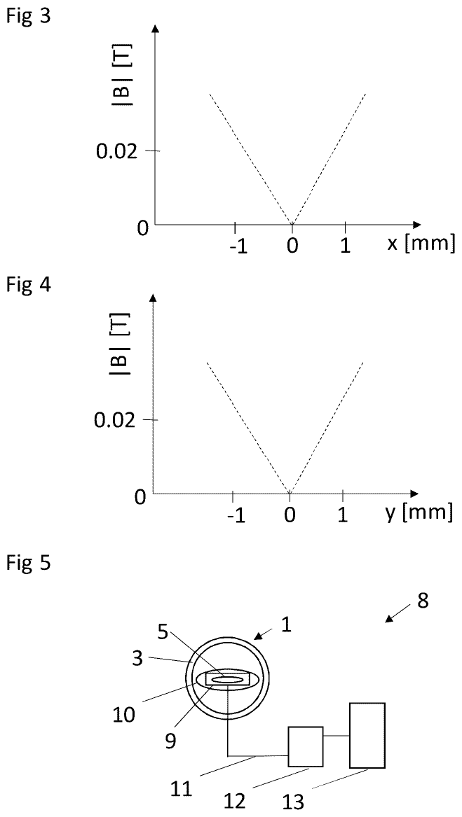

In FIGS. 3 and 4, magnitudes of the magnetic field being represented by absolute values of a magnetic field |B| in T are illustrated on a vertical axis dependent on a position x or y in mm being illustrated on a horizontal axis, respectively.

The horizontal axis of the diagram shown in FIG. 3 corresponds to the x-axis according to FIGS. 1 and 2. The horizontal axis of the diagram shown in FIG. 4 corresponds to the y-axis according to FIGS. 1 and 2. The position x or y being equal to 0 corresponds to a centre of the permanent magnet arrangement 2 according to FIGS. 1 and 2.

With respect to the centre of the permanent magnet arrangement 2, the absolute values of the magnetic flux density |B|, i.e. the magnitudes of the magnetic field, are symmetric. For negative position values x and y, the absolute values of the magnetic flux density |B|, i.e. the magnitudes of the magnetic field, have a negative slope and for positive position values x and y a positive slope.

A quantum computer 8 according to the exemplary embodiment of FIG. 5 comprises a quantum computing arrangement 1 according to one of the exemplarily embodiments of FIG. 1 or 2 as well as a quantum computing device 9 located within a chamber 10. The quantum computing device 9 is connected to external components of the quantum computer 8 through the chamber 10 by a plurality of connections 11. For example, the connections 11 connect the quantum computing device 9 with a control electronic 12 and a classical computer 13.

For example, the quantum computing device 9 is configured to trap, manipulate and measure trapped quantum particles, each being a qubit, within a space 5 during operation. For this, the quantum computing device 9 can comprise electrodes, light guides and/or internal electronics comprising electronic devices. The electronic devices can comprise circuitry, integrated electronic, and/or detectors, such as photon detectors and/or charge detectors, controllers. Exemplarily, the internal electronics are provided for pre-processing. For example, these components allow a measurement of a respective state of the qubits and allow gate operations on the qubits. Thus, the quantum computing device 9 is configured to trap the trapped quantum particles as well as to carry out operations and measurements on the trapped quantum particles.

The quantum computing device 9 is mounted in the chamber 10, wherein the chamber 10 can be an ultra-high vacuum chamber, an extreme-high vacuum chamber and/or a cryostat. If the chamber 10 is an ultra-high vacuum chamber or an extreme-high vacuum chamber, it is possible that the permanent magnet arrangement 2 is arranged outside the chamber 10. In this case the permanent magnet arrangement 2 surrounds the chamber 10. Alternatively, it is also possible to arrange the permanent magnet arrangement 2 within an ultra-high vacuum chamber or an extreme-high vacuum chamber or a cryostat.

Exemplarily, if the chamber 10 is a cryostat, the permanent magnet arrangement 2 is arranged inside the chamber 10 (not shown here). It is also conceivable that if the chamber 10 is a cryostat, the permanent magnet arrangement 2 can be arranged also outside the chamber 10 (not shown here).

The quantum computing device 9 is connected to the external electronic 12 via the connections 11. The external electronic 12 can be located at least partially inside and partially outside the chamber 10. Further, the external electronic 12 is connected to the classical computer 13.

The external electronic 12 comprises, exemplarily, analog to digital converters as well as signal generators such as radio frequency generators, microwave signal generators, low-frequency signal generators and/or direct current signal generators. Furthermore, the external electronic 12 can comprise a transistor-transistor logic, TTL.

Additionally, the external electronic 12 can further comprise at least one laser system configured to cool the to be trapped ions. Further, the laser system can be configured to excite a particular state of the trapped ions.

The classical computer 13 is configured, for example, to provide and receive digital signals. The digital signals correspond to control signals used for operations on the qubits as well as to measurement signals corresponding to a state of the qubits.

The external electronic 12 is, inter alia, configured to convert the digital signals to analog signals and vice versa. Therefore, the external electronic 12 is configured to provide the converted analog signals for manipulating the qubits to the quantum computing device 9. Further, the external electronic 12 is configured to provide measured analog signals from the quantum computing device 9 to the classical computer 13 or to process such signals to directly initiate some response signal generated by the control electronics 12.

The classical computer 13 is exemplarily configured to be provided with a specific algorithm, i.e. a predetermined quantum calculation solving a specific problem. The classical computer 13 is then configured to convert a compiled code, corresponding to the algorithm, to commands for the quantum computing device 9. The commands are subsequently forwarded via the external control electronic 12 to the quantum computing device 9. Furthermore, the classical computer 13 is configured to receive a measured outcome of the specific algorithm.

For example, all elements of the quantum computer 8, in particular all electronic elements of the quantum computer 8, are synchronized by an atomic clock reference, for example.

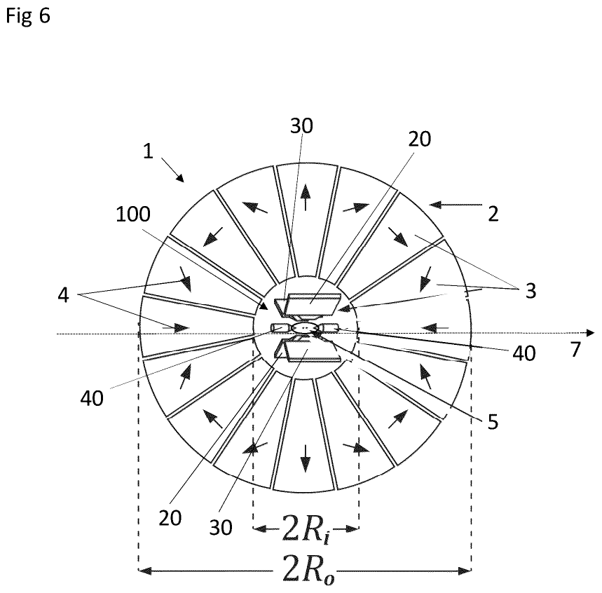

Quantum computing arrangements 1 according to the exemplary embodiments of FIGS. 6, 7 and 8 each comprises a permanent magnet arrangement 2 as described in connection with the exemplary embodiment of FIG. 1 as well as an ion trap 100.

According to FIG. 6, the ion trap 100 is a linear Paul trap for trapping ions along a first axis 7. A Paul trap is also known as quadrupole ion trap or radio frequency trap. It is a type of an ion trap 100 that uses dynamic electric fields to trap ions.

The linear Paul trap comprises two radio frequency, rf, electrodes 20, two direct current, dc, electrodes 30 and two end cap electrodes 40. Exemplarily, the end cap electrodes can be formed from a soft magnetic material, forming a yoke structure 60, in order to enhance a magnetic field gradient along the first axis 7.

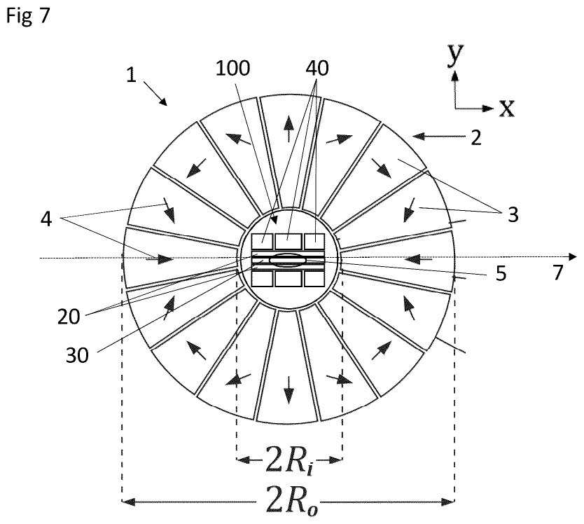

According to FIG. 7, the ion trap 100 is a planar Paul trap for trapping ions along a first axis 7. The planar Paul trap comprises two rf electrodes 20, a dc electrode 30 and end cap electrodes 40 as well as separating cap electrodes 41. All of these electrodes are metallic films and are arranged in a common electrode plane.

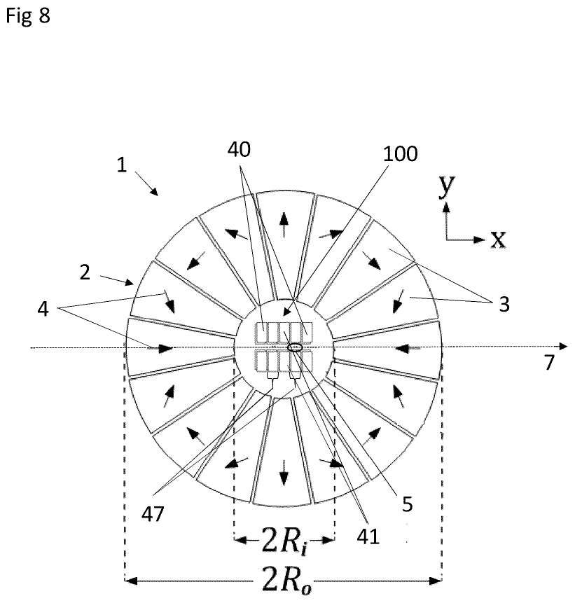

According to FIG. 8, the ion trap 100 is a segmented Paul trap for trapping ions along a predefined line, in particular the first axis 7. The segmented Paul trap comprises at least two sections 47, wherein each section 47 is configured to host one ion crystal comprising a plurality of tapped ions. Each section comprises two rf electrodes 20 and two dc electrodes 30, similarly arranged as described in FIG. 6. Furthermore, the sections are arranged between at least two end cap electrodes 40. All of these electrodes are metallic films and are arranged in two electrode planes, which are parallel to one another and stacked above one another.

The invention is not limited to the exemplary embodiments by their description. Rather, the invention encompasses any new feature as well as any combination of features, which in particular includes any combination of features in the claims, even if this feature or combination itself is not explicitly indicated in the claims or exemplary embodiments.

1.-18. (canceled)

19. A quantum computing arrangement comprising:
a permanent magnet arrangement; and
a space within the permanent magnet arrangement configured for at least two trapped quantum particles arranged along a first axis,
wherein the permanent magnet arrangement comprising a plurality of segments,
wherein each segment has a magnetisation direction,
wherein the magnetisation directions of at least four segments are different to one another thereby establishing a magnetic field with magnitudes being different from one another for different positions on the first axis, and
wherein a change of the magnitudes is at least 0.5 T/m.

20. The quantum computing arrangement according to claim 19,
wherein the segments surround the space in form of a ring, or
wherein the segments surround the space in form of a contour of a polygon.

21. The quantum computing arrangement according to claim 20, wherein the space is located at a centre region of the ring or the contour of the polygon.

22. The quantum computing arrangement according to claim 19, wherein distances between directly neighbouring segments are equal to one another.

23. The quantum computing arrangement according to claim 19, wherein a cross section of at least some of the segments has a shape of a quadrangle.

24. The quantum computing arrangement according to claim 19, wherein a cross section of at least some of the segments has a shape of a trapezoid.

25. The quantum computing arrangement according to claim 19, wherein all segments have the same shape.

26. The quantum computing arrangement according to claim 19, wherein the magnetisation directions of segments being arranged at opposite regions are directed in opposite directions.

27. The quantum computing arrangement according to claim 19, wherein at least some of the trapped quantum particles of the space form an at least two-level quantum system during operation of the quantum computing arrangement.

28. The quantum computing arrangement according to claim 19, wherein at least some of the trapped quantum particles of the space form a quantum bit during operation of the quantum computing arrangement.

29. The quantum computing arrangement according to claim 19, wherein a frequency difference of a transition between the trapped quantum particles is dependent on the magnetic field during operation of the quantum computing arrangement.

30. The quantum computing arrangement according to claim 19,
wherein a distance of directly neighbouring trapped quantum particles is at least 0.1 μm and at most 30 μm, and
wherein a frequency difference of a transition, in which a magnetic quantum number changes, between directly neighbouring trapped quantum particles is at least 10 kHz and at most 100 MHz, and/or
wherein a frequency difference of a transition, in which a magnetic quantum number does not change, between directly neighbouring trapped quantum particles is at least 1 kHz and at most 10 MHz.

31. The quantum computing arrangement according to claim 19,
wherein edges of segments, arranged at opposite regions and facing one another, have a minimal distance from one another of at least 0.001 cm and at most 100 cm, and
wherein each segment has an extent along the corresponding minimal distance of at least 0.001 cm and at most 100 cm.

32. The quantum computing arrangement according to claim 19, wherein a remanence of each of the segments is at least 0.1 T and at most 1.5 T.

33. The quantum computing arrangement according to claim 19, wherein the permanent magnet arrangement comprises NdFeB.

34. The quantum computing arrangement according to claim 19, further comprising at least one additional permanent magnet arrangement.

35. The quantum computing arrangement according to claim 34,
wherein the permanent magnet arrangement and the additional permanent magnet arrangement are rotated relative to each other, or
wherein the permanent magnet arrangement and the additional permanent magnet arrangement are parallel to each other.

36. The quantum computer comprising:
the quantum computing arrangement according to claim 19,
wherein the quantum computer is configured for performing quantum computations.
